(19) United States
(12) Patent Application Publication
(10) Pub. No.: US 2022/0159931 A1
(43) Pub. Date: May 26, 2022

(54) Retractable Animal Leash

(71) Applicant: John Eric Chapman, Gray, TN (US)

(72) Inventor: John Eric Chapman, Gray, TN (US)

(21) Appl. No.: 17/437,452

(22) PCT Filed: Mar. 12, 2020
(86) PCT No.: PCT/US20/22218

§ 371 Date: Sep. 9, 2021

Related U.S. Application Data
(60) Provisional application No. 62/817,722, filed on Mar. 13, 2019.

(51) Int. Cl. A01K 27/00; B65H 75/40; B65H 75/44

(52) U.S. Cl. CPC A01K 27/009; A01K 27/004; B65H 75/4423; A01K 27/008; B65H 75/406; A01K 27/006

(57) ABSTRACT

A handle having a gripping member. A base can be attached to a guidance device worn by an animal A retractable pulley assembly connects the base to the handle. A braking assembly has a trigger and a braking member. The retractable pulley assembly includes a spool, a wheel, an anchor, and a flexible member having a first end and a second end with the flexible member extending from the base to the handle, around the wheel, and to the anchor and with the flexible member being fixedly attached to the spool at the first end and to the anchor at the second end. The trigger actuates the braking member to frictionally engage the flexible member at an intermediate point between the flexible member first end and the flexible member second end to fix the distance between the handle and the base when the flexible member is pulled taut.

### CROSS REFERENCE TO RELATED APPLICATION

This application claims the benefit under 35 U.S.C. § 119(e) of co-pending U.S. Non-Provisional Application No. 62/817,722 entitled “RETRACTABLE ANIMAL LEASH” filed Mar. 13, 2019, which is incorporated herein by reference.

### TECHNICAL FIELD

The subject disclosure is directed to an animal leash system, and, more particularly, to an animal leash system that includes a handle, a base, and a pulley system that connects the handle to the base.

### BACKGROUND ART

Many animals, such as dogs, cats or other pets, and even humans such as children, can be tethered to a leash or other restraint held by a user. Such devices are common for use with a companion pet, but are frequently unused by the pets owner due to convenience and other reasons described herein. As leash laws in most communities are becoming more stringent and more routinely enforced, however, it is becoming less desirable to permit a companion pet (particularly a dog) to roam freely and unleashed. As a consequence, walking such pets while they are confined on leashes is becoming increasingly prevalent.

Leashes are available in a variety of sizes and types. There are chain leashes, strap leashes, and cord leashes. Some leashes extend and retract from a hand-held device. Conventionally, an animal is provided with a collar, a harness, or other animal guidance device, and a leash is attached to the collar when used to control the animal, and detached for storage on its own when unused. Typically, leashes and guidance devices are separate devices which that are removably attached to each other. Further, conventional uses of leashes require that the leash be detached from an animal when not in use, leading to a possibility that the leash can be misplaced or lost, or that it is not available at certain critical times.

Another problem with conventional leashes is the necessity of first obtaining the leash, collar or harness, and securing it to the animal before the walk can commence. Another inconvenience occurs when walking in an area where the leash is not required, such as in open space or at a dog park, and removing the leash from the pet while the pet is still restrained. When not in use, the owner is required to carry the leash, which can be a further inconvenience. In this manner, the leash can also become lost or misplaced during or before the walk, or the constant securing and unsecuring of the leash can cause problems when the user attempts to restrain the animal.

When not in use, the leash can become tangled. Impatient pets do not typically respond well to delay, and this waiting can lead to overanxious pet behavior such as jumping, whining, etc., and further increase the effort of attaching the leash to the pet's collar. If the leash cannot be quickly located, a pet owner can even resort to using items such as ropes or cords as a restraining device, which are typically not designed for use with pets.

Recent improvements to leashes include retractable leash assemblies and wearable leash assemblies that allow an animal to carry the leash while not in use by the owner of the animal, including “emergency leads.” However, these conventional leads are lacking in several critical respects. For example, the assemblies are not easily attached to the collar of the animal, or are specific to one size or breed of animal alone, and can eliminate the option of completely removing the leash assembly when the animal is indoors or otherwise is not in need of restraint. Additionally, the leash assemblies do not typically provide identification means in the event the animal and the owner become separated. In view of the foregoing, improved leash is needed.

### DISCLOSURE OF INVENTION

In various implementations, a leash system includes a handle having a gripping member. A base can be attached to a guidance device worn by an animal A retractable pulley assembly connects the base to the handle. A braking assembly has a trigger and a braking member. The retractable pulley assembly includes a spool, a wheel, an anchor, and a flexible member having a first end and a second end with the flexible member extending from the base to the handle, around the wheel, and to the anchor and with the flexible member being fixedly attached to the spool at the first end and to the anchor at the second end. The trigger actuates the braking member to frictionally engage the flexible member at an intermediate point between the flexible member first end and the flexible member second end to fix the distance between the handle and the base when the flexible member is pulled taut.

### BRIEF DESCRIPTION OF THE DRAWINGS

FIG. 1 is a schematic diagram of an operating environment in accordance with the subject disclosure.

FIG. 2 is a perspective view of a retractable leash system in accordance with the subject disclosure.

FIG. 3 is a fragmentary perspective view of a handle for a retractable leash system in accordance with the subject disclosure.

FIG. 4 is a plan view in cross section of a base for a retractable leash system in accordance with the subject disclosure.

FIG. 5 is a block diagram of another embodiment of a retractable leash system in accordance with the subject disclosure.

FIG. 6 is a block diagram of another embodiment of a retractable leash system in accordance with the subject disclosure.

FIG. 7 is a block diagram of another embodiment of a retractable leash system in accordance with the subject disclosure.

FIG. 8 is a plan view in cross section of another embodiment of a handle for a retractable leash system in accordance with the subject disclosure.

FIG. 9 is an exemplary process in accordance with the subject disclosure.

### MODES FOR CARRYING OUT THE INVENTION

An animal leash system is disclosed. The animal leash system includes a handle, a base, and a pulley system that connects the handle to the base. The pulley system can include a flexible member that is fixedly attached to either the handle or the base at one end, loops around a wheel that is mounted on the other object, and attaches to an anchor at the other end. A braking system includes a member that can be moved to frictionally engage the flexible member at an intermediate point to fix the maximum distance between the base and the handle when the flexible member is taut.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

The subject leash system is a retractable animal leash that includes a pulley assembly. The pulley assembly includes a brake for gripping a flexible member within the pulley assembly to allow the leash to be extended and retracted to varying lengths. The pulley assembly provides a user with the ability to vary the leash length, which differs from known retractable leashes that retract to a fixed length.

Additionally, in some embodiments, the pulley assembly can be mounted, removably, on a guidance device, such as a harness. The leash system can include other features, such as a Global Positioning System (GPS) device, a flashlight, a solar powered device that can store power during the day and flash at night, and a compartment for storing animal waste bags. In other embodiments, the leash system can be configured to attach to pet costumes.

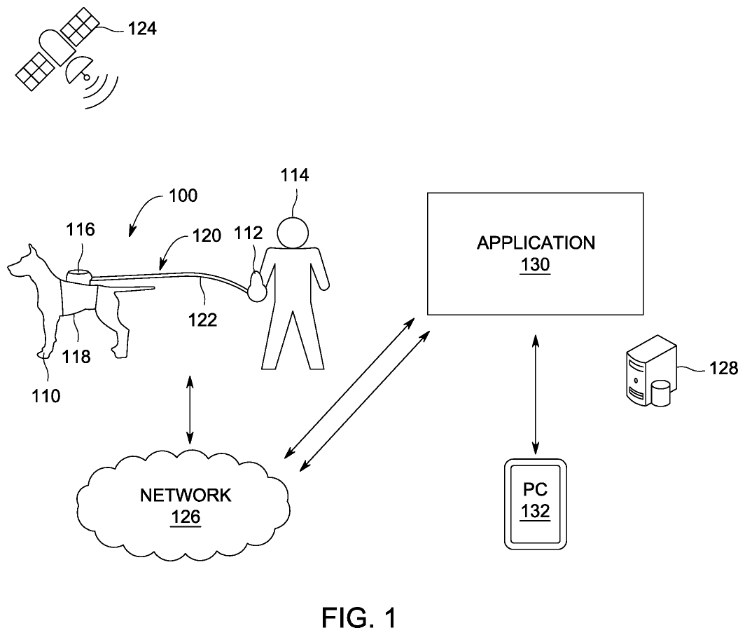

Referring now to FIG. 1, there is shown an operating environment for a leash system, generally designated with the numeral 100, for an animal 110. The leash system 100 includes a handle 112 that can be gripped by a user 114 and a base 116. The leash system 100 is particularly adapted to allow the user 114 to control the length of the leash (i.e., the maximum distance between the handle 112 and the base 116) by activating a release on the handle 112. In this exemplary embodiment, the leash system 100 is particularly adapted for use with a dog, but the leash system 100 can be used with any other suitable animal, including humans.

The base 116 can be configured for removable attachment to a guidance device 118 that can be a harness, a collar, a harness-leash combo, or any other suitable guidance device. In this exemplary embodiment, the bases 116 is mounted on the guidance device 118, which is removably attached to the animal 110. In other embodiments, the base 116 can be configured to attach to or otherwise be incorporated into a pet costume.

The handle 112 connects to the base 116 with a retractable pulley assembly 120 that includes a flexible member 122. The flexible member 122 can be inserted into one of the handle 112 or the base 116 and have both ends anchored to the component. The flexible member 122 can be a rope, a strap, a cord, or any other suitable flexible member or tethering device.

The retractable pulley assembly 120 sets the length of the leash by gripping the flexible member 122 with the handle 112, so that the handle 112 and the base 116 are separated by a maximum when the flexible member 122 is pulled taut by the animal 110. Unlike conventional leashes, either the handle 112 or the base 116 can be configured to adjust the length of the leash by gripping the flexible member 122 at an intermediate point before the animal 110 fully extends the flexible member 122 to its maximum length by running away from the user 114.

In some embodiments, the leash system 100 can be configured for implementation for interaction with a GPS device 124 to monitor the position of the animal 110, particularly when the flexible member 122 breaks and the animal 110 runs free. This feature can allow the user 114 to track down the animal 110 if the animal 110 has not been implanted with a tracking chip or if the implanted tracking chip fails, which can occur in as much as 40% of the time.

In other embodiments, the leash system 100 can be configured to interact with network 126. The network 126 can be connected to interface with a server 128 having applications 130 running thereon. The server 128 can connect to a PC 132, such as a smartphone, tablet, desktop or other personal computing device. The PC 132 can monitor the positioning of the animal 110 through the server 128 and the network 126. In some embodiments, the PC 132 can be configured to control certain functions of the leash system 100.

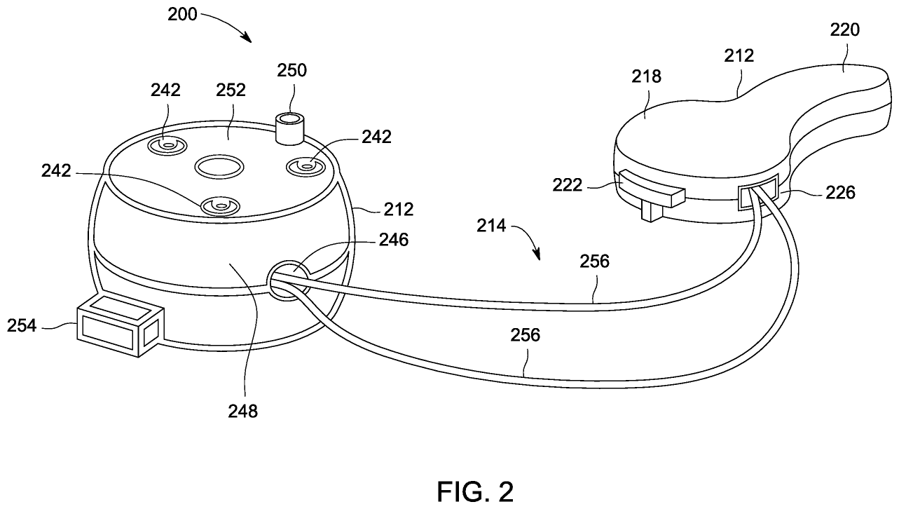

Referring now to FIGS. 2-4 with continuing reference to the foregoing figure, a retractable leash system, generally designated by the numeral 200, is shown. Like the embodiment shown in FIG. 1, the leash system 200 is particularly adapted for use with an animal, such as animal 110. The animal 110 can be a dog or other suitable animal, such as a human The retractable leash system 200 includes a handle 210, a base 212, a retractable pulley system 214, and a braking assembly 216.

The retractable pulley system 214 connects the handle 210 to the base 212. The braking assembly 216 frictionally engages the retractable pulley system 214 to adjust the length of the leash (i.e., the maximum distance between the handle 210 and the base 212).

The handle 210 is an essentially extended tubular member that has essentially circular tubular body 218 with an elongated tubular gripping member 220 extending therefrom. The tubular body 218 is substantially wider than the gripping member 220. The gripping member 220 is contoured to facilitate the grasp of a user, such as the user 114 shown in FIG. 1. A locking projection 222 extends from body 218 in the opposite direction from the gripping member 220. In this exemplary embodiment, the handle 201 is a lot smaller than a typical retractable dog leash.

The body 218 defines an inner chamber 224 and includes a tubular slot 226 that communicates with the inner chamber 224. A wheel 228 is mounted for rotation on an axle assembly 230 within the inner chamber 224. The braking assembly 216 is mounted within the inner chamber 224 to abut the wheel 228. The braking assembly 216 includes a braking member 232 that is pivotally mounted with a pin 234. The braking member 232 includes an end 236 that extends through the body 218 to define a thumb trigger. A plurality of tubular connectors 238 are formed within the tubular gripping member 220.

The base 212 is an essentially cylindrical tube that defines an inner chamber 240 with a plurality of integrally molded tubular members that form anchors 242 extending therethrough. A spool 244 is mounted within the inner chamber 240. The base 212 includes an opening 246 in an outer wall 248 that communicates with the inner chamber 240. A receptacle 250 is formed on an upper surface 252 that is contoured to receive the locking projection 222 to clamp the handle 210 to the base 212 in a releasable manner

The base 212 is particularly adapted to be removably attached to a guidance device (not shown), such as the guidance device 118 shown in FIG. 1. A strap slot 254 extends from the base 212 to facilitate a removable connection to the guidance device 118.

The retractable pulley system 214 includes the wheel 228, the spool 244, at least one of the anchors 242, and a flexible member 256 having a first end 258 and a second end 260. The flexible member 256 can be essentially identical to the flexible member 122 shown in FIG. 1.

The first end 258 of the flexible member 256 can be fixedly attached to the spool 244 within the inner chamber 242 and can extend through the opening 246 outside of the base 212. The flexible member 256 extends from the base 212 through the tubular slot 226 in the handle 210 to loop around the wheel 228 within the inner chamber 224. The flexible member 256 can extend back to the base 212 through the opening 246 to fixedly attach to one of the anchors 242. Excess slack for the flexible member 256 can be wrapped around the spool 244.

When the handle 210 is separated from the base 212, the braking assembly 216 can be activated by the thumb trigger to actuate the braking member 232 to pivot about the pin 234. The pivoting motion of the braking member 232 causes the braking member 232 to frictionally engage the flexible member 256 at an intermediate point between the first end 258 and the second end 260. The engagement fixes the maximum distance between the handle 210 and the base 212 when the flexible member 256 is pulled taut.

The components of the retractable leash system 200, including the handle 210, the base 212, the retractable pulley system 214, and the braking assembly 216, can be made from any suitable material through any suitable manufacturing method. Suitable materials include flexible materials, rigid materials, or materials that are intermediate between flexible materials and rigid materials. Suitable materials also include metals, ceramics, plastics, and composites. The cost of the materials can range from relatively inexpensive to very expensive.

It should be understood that each component of the invention, individual components of the present invention can be made of a material that is specifically suited for the individual structural tolerances. Any combination of material or a uniform application of a single material that results in an acceptably robust structure is suitable. In this embodiment, the base 212 and the handle 210 are made from plastic materials.

The leash system 200 can be packaged and sold as a single kit with the handle 210, the base 212, the retractable pulley system 214, and the braking assembly 216, being individual components of the kit. Alternatively, the handle 210, the base 212, the retractable pulley system 214, and the braking assembly 216 can be sold individually, with other components, or in various combinations, thereof.

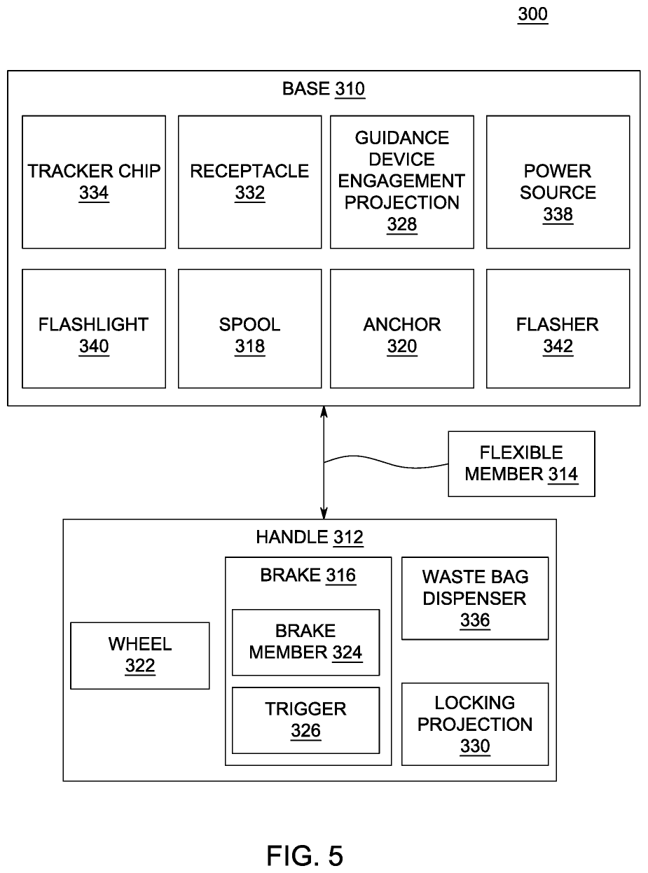

Referring now to FIG. 5 with continuing reference to the foregoing figures, another embodiment of a retractable leash system, generally designated by the numeral 300, is shown. Like the embodiment shown in FIGS. 2-4, the retractable leash system 300 includes a base 310, a handle 312, a flexible member 314 connecting the base 310 to the handle 312, and a brake 316. This embodiment of the retractable leash system 300 includes additional features, as compared to the retractable leash system 200 shown in FIGS. 2-4, and, in particular, is configured to interact with the network 126, the server 128, the application 130, and/or the PC 132 shown in FIG. 1.

The flexible member 314 is fixedly attached to a spool 318 and an anchor 320 that are mounted on the base 310 at each end to form a loop. The flexible member 314 wraps around a wheel 322 that is mounted on the handle 312 at some intermediate point to frictionally engage the brake 316 when it is activated. The brake 316 includes a pivotally attached braking member 324 and a trigger 326. The trigger 326 activates the braking member 324 to frictionally engage the flexible member 314 to fix the length of the leash when the flexible member 314 is pulled taut.

The base 310 can include guidance device engagement projection 328 that is particularly adapted to be removably attached to a guidance device (not shown), such as the guidance device 118 shown in FIG. 1. The guidance device engagement projection 328 extends from the base 310 to facilitate a removable connection to the guidance device 118.

Unlike the embodiment shown in FIGS. 2-4, the leash system 300 and, more specifically, the base 310 includes a tracker chip 334 to allow the position of the base 310 to be tracked. In some embodiments, the tracker chip 334 is a GPS tracking chip that is configured to interact with a GPS system, such as the GPS system 124 shown in FIG. 1. In other embodiments, the tracker chip 334 is a short-range wireless tracking chip that interacts with the network 126 shown in FIG. 1. The server 128, the application 130, and the PC 132 can be configured to track the tracker chip 334 using the network 126. In such embodiments, the tracker chip 334 interacts with the network 126 through a short-wavelength UHF radio broadcast device that broadcasts radio waves in the ISM band from 2.4 to 2.485 GHz (i.e., a Bluetooth broadcast).

In this exemplary embodiment, the handle 312 can include a waste bag dispenser 336 that stores bags for animal waste. The base 310 can include a portable power source 338, a flashlight 340, and a flasher 342. The power source 338 can be a solar powered power source that can power the tracker chip 334, the flashlight 340 and/or the flasher 342. The flashlight 340 and the flasher 342 can be configured to interact with the tracker chip 334 to activate when the base 310 is sufficiently separated from the handle 312 to determine that the animal (not shown) is lost. Alternatively, the tracker chip 334 can be configured to determine that the animal (not shown) is lost based upon its global position.

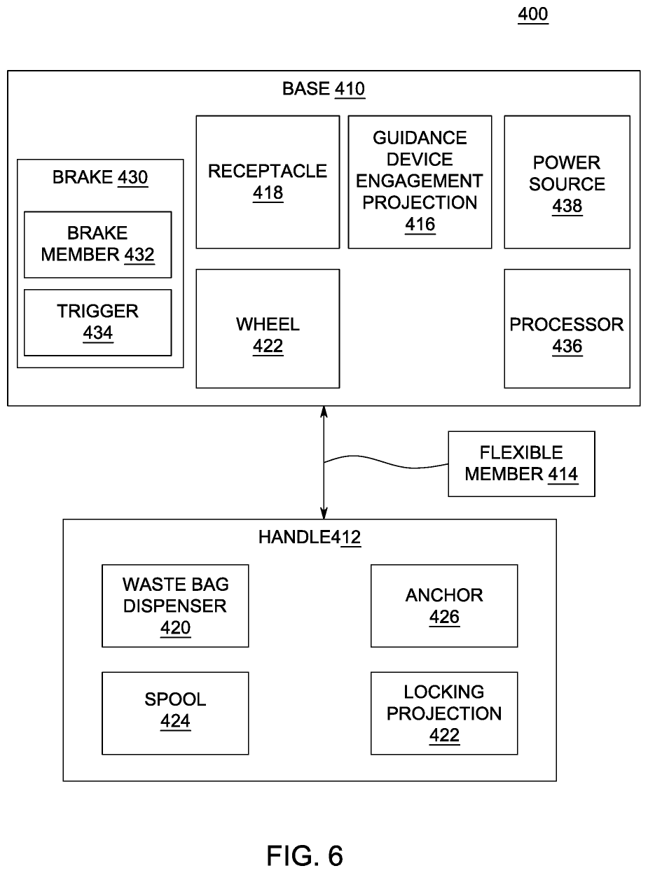

Referring now to FIG. 6 with continuing reference to the foregoing figures, another embodiment of a retractable leash system, generally designated by the numeral 400, is shown. The retractable leash system 400 includes a base 410, a handle 412, a flexible member 414 connecting the base 410 to the handle 412. Like the embodiment shown in FIG. 5, the base 410 includes a guidance device engagement projection 416 and a receptacle 418. The handle 412 includes a waste bag dispenser 420 and a locking projection 422 for inserting into the receptacle 418.

Unlike the embodiment shown in FIG. 5, a spool 424 is mounted on the base 410. A wheel 426 and an anchor 428 is mounted on the handle 412. A brake 430 is mounted on the base 410. The brake 430 includes a brake member 432 and a trigger 434. The flexible member 414 is fixedly attached to the spool 424 and to the anchor 428 at each end to form a loop. The flexible member 414 wraps around the wheel 426 at some intermediate point to frictionally engage the brake member 432 when activated by the trigger 434 to fix the length of the leash when the flexible member 414 is pulled taut. Optionally, the brake 430 can include a lock 436 that locks the brake member 432 in place when it frictionally engages the flexible member 414.

In some embodiments, the base 410 includes a processor 438 and a power supply 440 that powers the processor 438. The processor 438 can be configured to connect to the trigger 434 to activate the brake member 432 to frictionally engage the brake member 432. The processor 438 can be configured to interact with a network, such as the network 126 shown in FIG. 1. The server 128, the application 130, and the PC 132 can be configured to communicate with processor 438 to activate the brake member 432.

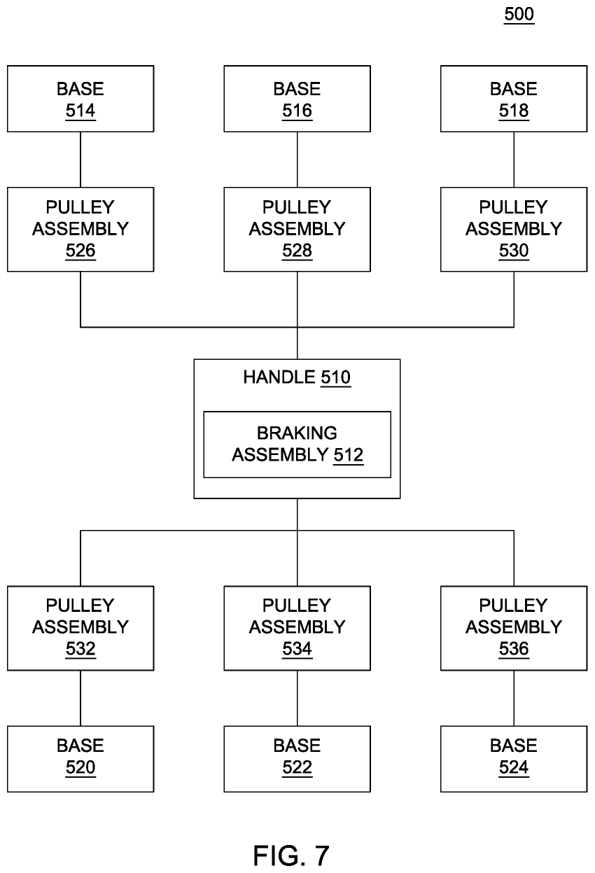

Referring now to FIG. 7 with continuing reference to the foregoing figures, another embodiment of a retractable leash system, generally designated by the numeral 500, is shown. Like the embodiment shown in FIGS. 2-5, the retractable leash system 400 includes a handle 512 with a braking system 514.

Unlike the embodiments shown in FIGS. 1-6, the retractable leash system 500 includes a plurality of bases 516-524. Each one of the bases 516-524 is mounted, removably, on an animal, such as the animal 110 shown in FIG. 1. Each one of the bases 516-524 is connected to the handle 512 through one of the pulley assemblies 526-536. Through this configuration, a single handle 512 controls a plurality of bases 516-524.

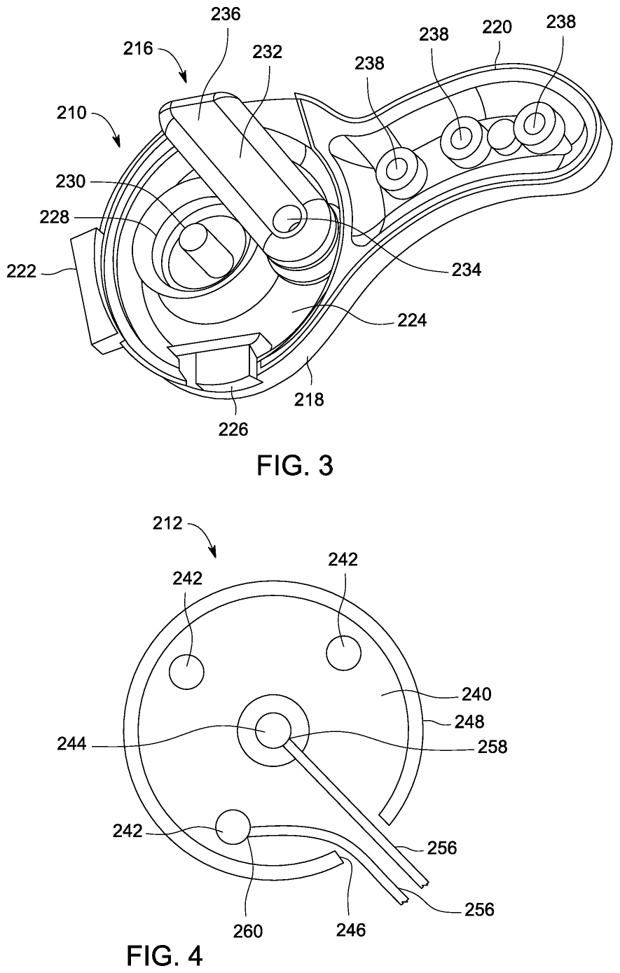

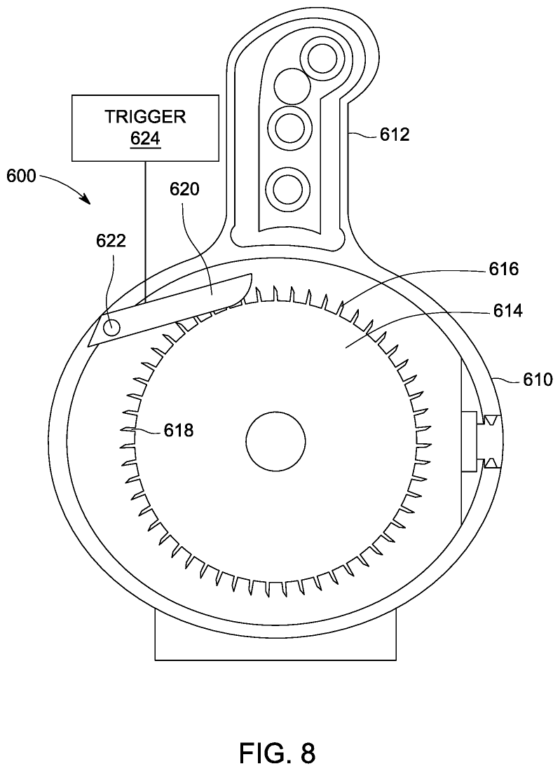

Referring now to FIG. 8 with continuing reference to the foregoing figures, another embodiment of a handle, generally designated by the numeral 600, is shown. The handle 600 is suitable for use in place of the handle 210 shown in FIG. 3. Like the embodiment shown in FIG. 3, the handle 600 is an essentially extended tubular member that has essentially circular tubular body 610 with an elongated tubular gripping member 612 extending therefrom.

Unlike the embodiment shown in FIG. 3, the handle 600 includes a flywheel 614 having a plurality of pointed projections 616 extending from an outer edge 618 and a braking member 620 mounted to pivot about a pivot point 622. The braking member 620 can be activated by a trigger 624 that presses downwardly to cause the braking member 620 to engage the pointed projections 616 to lock the flywheel 614 in place.

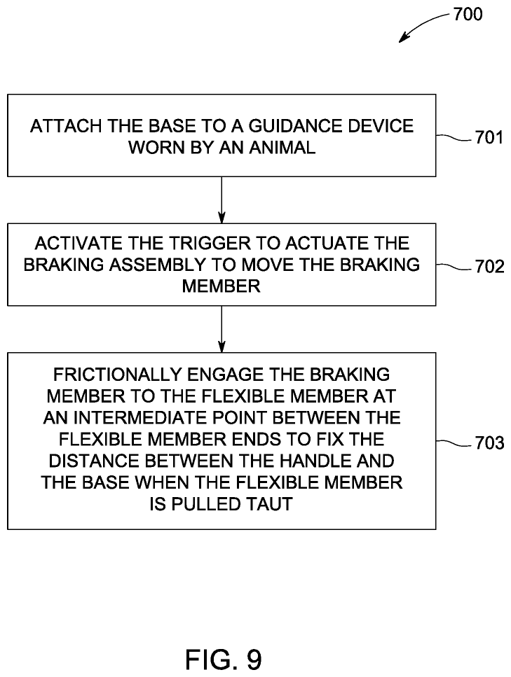

Referring to FIG. 9 with continuing reference to the foregoing figures, a method 700 of using leash system in accordance with the described subject matter is shown. Method 700, or portions thereof, can be performed using the leash system 100 shown in FIG. 1, the leash system 200 shown in FIGS. 2-4, the leash system 300 shown in FIG. 5, the leash system 400 shown in FIG. 6, and/or the leash system 500 shown in FIG. 7.

The method 700 can be performed using a leash system that includes a base, a handle, a flexible member, and a braking assembly. A spool and an anchor point can be mounted on one of the base or the handle with a wheel and the braking assembly mounted on the other one. The braking assembly includes a braking member and a trigger. The flexible member can be fixedly attached to the spool at one end, fixedly attached to the anchor at the other end, and can extend around the wheel.

At 701, the base is attached to a guidance device worn by an animal. In this exemplary embodiment, the animal can be the animal 110 shown in FIG. 1. The base can be the base 116 shown in FIG. 1, the base 212 shown in FIGS. 2-4, the base 310 shown in FIG. 5, the base 410 shown in FIG. 6, and the bases 516-524 shown in FIG. 7.

At 702, the trigger is activated to actuate the braking assembly to move the braking member. In this exemplary embodiment, the braking assembly can be the braking assembly 218 shown in FIGS. 2-4, the brake 316 shown in FIG. 5, the brake 430 shown in FIG. 6, and/or the braking assembly 512 shown in FIG. 7. The trigger can be the end 236 shown in FIGS. 2-4, the trigger 326 shown in FIG. 5 and/or the trigger 434 shown in FIG. 6. The braking member can be the braking member 232 shown in FIGS. 2-4, the brake member 324 shown in FIG. 5 and/or the brake member 432 shown in FIG. 6.

At 703, the braking member frictionally engages flexible member at an intermediate point between the flexible member ends to fix the distance between the handle and the base when the flexible member is pulled taut. In this exemplary embodiment, the handle can be the handle 112 shown in FIG. 1, the handle 212 shown in FIGS. 2-4, the handle 312 shown in FIG. 5, the handle 412 shown in FIG. 6 and/or the handle 512 shown in FIG. 7. The flexible member can be the flexible member 122 shown in FIG. 1, the flexible member 256 shown in FIGS. 2-4, the flexible member 314 shown in FIG. 5 and/or the flexible member 414 shown in FIG. 6.

### Supported Features and Embodiments

The detailed description provided above in connection with the appended drawings explicitly describes and supports various features of an improved retractable leash. By way of illustration and not limitation, supported embodiments include a leash system comprising: a handle having a gripping member, a base for attaching to a guidance device worn by an animal, a retractable pulley assembly connecting the base to the handle, and a braking assembly having a trigger and a braking member, wherein the retractable pulley assembly includes a spool, a wheel, an anchor, and a flexible member having a first end and a second end with the flexible member extending from the base to the handle, around the wheel, and to the anchor and with the flexible member being fixedly attached to the spool at the first end and to the anchor at the second end, and wherein the trigger actuates the braking member to frictionally engage the flexible member at an intermediate point between the flexible member first end and the flexible member second end to fix the distance between the handle and the base when the flexible member is pulled taut.

Supported embodiments include the foregoing leash system, wherein the base is removably attached to the guidance device.

Supported embodiments include any of the foregoing leash systems, wherein the spool is mounted on the base, the wheel is mounted for rotation on the handle, and the anchor is integral with the base.

Supported embodiments include any of the foregoing leash systems, wherein the handle includes a housing defining a first internal chamber and the wheel is mounted in the first internal chamber.

Supported embodiments include any of the foregoing leash systems, wherein the base defines a second internal chamber and the spool is mounted within the second internal chamber.

Supported embodiments include any of the foregoing leash systems, wherein the anchor is mounted within the second internal chamber.

Supported embodiments include any of the foregoing leash systems, wherein the braking member is pivotally mounted within first internal chamber.

Supported embodiments include any of the foregoing leash systems, wherein the flexible member is selected from the group consisting of a rope, a strap, and a cord.

Supported embodiments include any of the foregoing leash systems, further comprising: a tracker chip.

Supported embodiments include any of the foregoing leash systems, wherein the tracker chip is selected from the group consisting of a global positioning system tracking chip and a short-range wireless tracking chip.

Supported embodiments include any of the foregoing leash systems, wherein the handle includes a waste bag dispenser.

Supported embodiments include any of the foregoing leash systems, wherein the handle is configured for mounting on the base.

Supported embodiments include any of the foregoing leash systems, wherein the base includes a flash light.

Supported embodiments include any of the foregoing leash systems, wherein the base includes a flashing device and a power source for powering the flashing device.

Supported embodiments include any of the foregoing leash systems, wherein the power source is a solar powered power source.

Supported embodiments include any of the foregoing leash systems, wherein the trigger is a thumb trigger.

Supported embodiments include any of the foregoing leash systems, further comprising: the guidance device.

Supported embodiments include any of the foregoing leash systems, wherein the guidance device is selected from the group consisting of a collar and a harness.

Supported embodiments include a kit, a method, an apparatus, and/or means for implementing any of the foregoing systems or a portion thereof.

Supported embodiments include any of the foregoing leash systems, wherein the base includes a tubular member for engaging the guidance device.

Supported embodiments include a method for utilizing a leash system, wherein the leash system includes a base and a handle, wherein a spool and an anchor point are mounted on one of the base and the handle, wherein a wheel and a braking assembly having a braking member and a trigger are mounted on the other one of the base and the handle, wherein a flexible member is fixedly attached to the spool at one end, fixedly attached to the anchor at the other end, and extends around the wheel, the method comprising: attaching the base to a guidance device worn by an animal, activating the trigger to actuate the braking assembly to move the braking member, and frictionally engaging the braking member to the flexible member at an intermediate point between the flexible member ends to fix the distance between the handle and the base when the flexible member is pulled taut.

Supported embodiments include a leash system comprising: a handle having a gripping member, a base for attaching to a guidance device worn by an animal, pulley means for connecting the handle to the base, the pulley means having a flexible member having a first end and a second end with the flexible member extending from the base to the handle and back, and braking means for frictionally engaging the flexible member at an intermediate point between the flexible member first end and the flexible member second end to fix the distance between the handle and the base when the flexible member is pulled taut.

Supported embodiments include the foregoing leash system, further comprising: triggering means for actuating the braking means.

Supported embodiments include any of the foregoing leash systems, wherein the guidance device is removably attached to the base.

Supported embodiments include a kit, a method, an apparatus, and/or means for implementing any of the foregoing systems or a portion thereof.

Supported embodiments can provide various attendant and/or technical advantages in terms of a leash system that includes a flexible leash member that is wearable on the dog. The length of the leash can be controlled through the use of a pulley system with a mechanical grip that frictionally engages the flexible leash member.

Supported embodiments include a leash system that is particularly adapted for mounting on harness.

Supported embodiments include a retractable leash system that does not need manual adjustments or a switch positioned on the animal

Supported embodiments include a retractable leash system that includes a tracker chip that is positioned on the animal that can be used to track the position of the animal It is particularly adapted for use with pets that have an implanted chip because over 40% of those implanted chips fail.

Supported embodiments include a retractable leash system that includes a lightweight handle.

The detailed description provided above in connection with the appended drawings is intended as a description of examples and is not intended to represent the only forms in which the present examples can be constructed or utilized.

It is to be understood that the configurations and/or approaches described herein are exemplary in nature, and that the described embodiments, implementations and/or examples are not to be considered in a limiting sense, because numerous variations are possible. For example, it is contemplated that the lock mechanism that holds the braking member in place for the embodiment disclosed in FIG. 6 can be included in the other disclosed embodiments. Additionally, other structures are contemplated for clamping the handle to the base in place of the disclosed receptacle-projection clamping structure.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. A leash system comprising:
a handle having a gripping member,
a base for attaching to a guidance device worn by an animal,
a retractable pulley assembly connecting the base to the handle, and
a braking assembly having a trigger and a braking member,
wherein the retractable pulley assembly includes a spool, a wheel, an anchor, and a flexible member having a first end and a second end with the flexible member extending from the base to the handle, around the wheel, and to the anchor and with the flexible member being fixedly attached to the spool at the first end and to the anchor at the second end, and
wherein the trigger actuates the braking member to frictionally engage the flexible member at an intermediate point between the flexible member first end and the flexible member second end to fix the distance between the handle and the base when the flexible member is pulled taut.

2. The leash system of claim 1, wherein the base is removably attached to the guidance device.

3. The leash system of claim 1, wherein the spool is mounted on the base, the wheel is mounted for rotation on the handle, and the anchor is integral with the base.

4. The leash system of claim 3, wherein the handle includes a housing defining a first internal chamber and the wheel is mounted in the first internal chamber.

5. The leash system of claim 4, wherein the base defines a second internal chamber and the spool is mounted within the second internal chamber.

6. The leash system of claim 5, wherein the anchor is mounted within the second internal chamber.

7. The leash system of claim 4, wherein the braking member is pivotally mounted within first internal chamber.

8. The leash system of claim 1, wherein the flexible member is selected from the group consisting of a rope, a strap, and a cord.

9. The leash system of claim 1, further comprising:
a tracker chip.

10. The leash system of claim 9, wherein the tracker chip is selected from the group consisting of a global positioning system tracking chip and a short-range wireless tracking chip.

11. The leash system of claim 1, wherein the handle includes a waste bag dispenser.

12. The leash system of claim 1, wherein the handle is configured for mounting on the base.

13. The leash system of claim 1, wherein the base includes a flash light.

14. The leash system of claim 1, wherein the base includes a flashing device and a power source for powering the flashing device.

15. The leash system of claim 14, wherein the power source is a solar powered power source.

16. The leash system of claim 1, wherein the trigger is a thumb trigger.

17. The leash system of claim 1, further comprising:
the guidance device.

18. The leash system of claim 1, wherein the guidance device is selected from the group consisting of a collar and a harness.

19. The leash system of claim 1, wherein the base includes a tubular member for engaging the guidance device.

20. A method for utilizing a leash system,
wherein the leash system includes a base and a handle,
wherein a spool and an anchor point are mounted on one of the base and the handle,
wherein a wheel and a braking assembly having a braking member and a trigger are mounted on the other one of the base and the handle,
wherein a flexible member is fixedly attached to the spool at one end, fixedly attached to the anchor at the other end, and extends around the wheel, the method comprising:
attaching the base to a guidance device worn by an animal,
activating the trigger to actuate the braking assembly to move the braking member, and
frictionally engaging the braking member to the flexible member at an intermediate point between the flexible member ends to fix the distance between the handle and the base when the flexible member is pulled taut.
